(19) United States
(12) Patent Application Publication
(10) Pub. No.: US 2011/0222837 A1
(43) Pub. Date: Sep. 15, 2011

(54) MANAGEMENT OF PICTURE REFERENCING IN VIDEO STREAMS FOR PLURAL PLAYBACK MODES

(75) Inventors: Benjamin L. Walton, Vancouver (CA); Arturo A. Rodriguez, Norcross, GA (US); Jaehan In, Coquitlam (CA); James Au, Richmond (CA)

(73) Assignee: Cisco Technology, Inc., San Jose, CA (US)

(21) Appl. No.: 12/722,117

(22) Filed: Mar. 11, 2010

(51) Int. Cl. H04N 5/93; H04N 7/26; H04N 5/783; H04N 5/917

(52) U.S. Cl. 386/347; 375/240.25; 386/E05.028; 375/E07.027; 386/330

(57) ABSTRACT

In one embodiment, a system, comprising an encoder comprising memory with personal video recording assist (PVRA) logic; and a processor configured to execute the PVRA logic to: provide a reference picture reordering command (RPRC) in association with one or more pictures of a video stream to be received in a video stream receive-and-process (VSRP) device, the RPRC configured to cause the VSRP device to reorder or modify associations of reference pictures to ascending reference indices of a derived, default reference picture list such that lower tier number pictures precede higher tier number pictures in a modified reference picture list used for decoding the one or more pictures.

### TECHNICAL FIELD

This disclosure relates in general to processing of video streams.

### BACKGROUND

In network systems such as subscriber television systems, a digital home communication terminal (“DHCT”), otherwise known as the set-top box, is capable of providing video services connected to the subscriber television system, and is typically located at the user's premises and connected to the subscriber television system, such as, for example, a cable or satellite network. The DHCT includes hardware and software necessary to provide digital video services to the end user with various levels of usability and/or functionality. One of the features of the DHCT includes the ability to receive and decode a digital video signal received as a compressed video signal. Another feature of the DHCT includes providing Personal Video Recording (PVR) functionality through the use of a storage device coupled to the DHCT. When providing this PVR functionality or other stream manipulation functionality for formatted digital video streams of Advanced Video Coding (AVC), referred to herein as AVC streams, associations of reference indices to reference pictures derived while processing the video stream (e.g., as calculated according to ISO/IEC 14496-10 or herein AVC specification) may not always provide proper picture identification suitable for a particular stream manipulation or PVR operation.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates an example environment in which Personal Video Recording Assist (PVRA) systems and methods may be implemented.

FIG. 2 is a block diagram of an example embodiment of an encoder that provides reference picture reordering commands (RPRCs) in an embodiment of a PVRA system.

FIG. 3 is a block diagram of an example embodiment of a video stream receive-and-process (VSRP) device comprising an embodiment of a PVRA system.

FIGS. 4A-4D are block diagrams that illustrates an example relationship between tiers, tier numbers, and certain trick modes in an embodiment of a PVRA system.

FIGS. 5A-5C are block diagrams that illustrate default reference picture lists derived in an embodiment of a PVRA system.

FIGS. 6A-6D are block diagrams that illustrate an example sequence of pictures and information associated with the provision of default and trick mode reference picture lists.

FIGS. 7A-7B are block diagrams that illustrate one embodiment of an example trick mode reference picture reordering scheme.

FIG. 8 is a block diagram that illustrates another embodiment of an example trick mode reference picture reordering scheme.

FIG. 9 is a flow diagram that illustrates one example PVRA method embodiment to modify associations of pictures to ascending reference indices based on receipt and interpretation by a VSRP device of an RPRC.

FIG. 10 is a flow diagram that illustrates one example method embodiment implemented by an encoder in an embodiment of a PVRA system.

### DESCRIPTION OF EXAMPLE EMBODIMENTS

### Overview

In one embodiment, a system, comprising an encoder comprising memory with personal video recording assist (PVRA) logic; and a processor configured to execute the PVRA logic to: provide a reference picture reordering command (RPRC) in association with one or more pictures of a video stream to be received in a video stream receive-and-process (VSRP) device, the RPRC configured to cause the VSRP device to reorder or modify associations of reference pictures to ascending reference indices of a derived, default reference picture list such that lower tier number pictures precede higher tier number pictures in a modified reference picture list used for decoding the one or more pictures.

In one method embodiment, receiving at a video stream receive-and-process (VSRP) device a transport stream including a video stream having plural compressed pictures, one or more of the plural compressed pictures associated with one or more respective reference picture lists and one or more reference picture reordering commands (RPRCs), the reference picture lists each comprising an association of reference pictures of a decoded picture buffer (DPB) for a given picture to be decompressed to ascending reference indices of the respective one or more reference picture lists; for the given picture to be decompressed, modifying the association of a first reference picture of the DPB from a second reference index to a first reference index responsive to the one or more RPRCs, wherein the association of the second reference index to the first reference picture corresponds to a default reference picture list; associating a second reference picture of the DPB to the second reference index responsive to the one or more RPRCs; and decompressing the given picture for output during a trick mode operation without decompressing the second reference picture.

### Example Embodiments

Disclosed herein are various example embodiments of Personal Video Recording Assist (PVRA) systems and methods (collectively, referred to herein also as a PVRA system or PVRA systems) that convey the associations of reference pictures to ascending reference indices of reference picture lists (e.g., L0 and/or L1) and reference picture reordering commands (or RPRCs) delivered in, or associated with, a video stream, and/or pictures of the video stream. The reference picture lists are derived in accordance to the Advanced Video Coding (AVC) specification (ISO/IEC 14496-10). In one embodiment of a PVRA system, a video stream emitter (e.g., network device or system such as a server, encoder, splicing device, etc.) located at a headend, hub, node, or other video (or multi-media) source location conditionally provides a reference picture reordering command corresponding to a respective decodable picture of the video stream. The video stream emitter (VSE) comprises logic to determine whether to issue RPRC for a given picture that references pictures, and responsive to a determination that issuance is warranted or otherwise, provides the RPRC and, as required per the provided RPRC, modifies referenced pictures in a reference picture list corresponding in a compressed version of the given picture in accordance with the issued RPRC. The VSE provides the RPRC and reference indices in accordance with the RPRC for respective corresponding pictures of a video stream to one or more video stream receive-and-process (VSRP) devices.

In one embodiment, a first portion of the reference pictures of a first reference picture list that correspond to a given picture in the video stream may be modified whereas a second portion of the reference pictures of the first reference picture list are not modified in accordance to the issued RPRC. In an alternate embodiment, all of the reference pictures of the first reference picture list of a given picture are modified in accordance to the particular issued RPRC.

A VSRP device receives the pictures of the video stream, the reference indices, and when included, the RPRC(s). In one embodiment, responsive to a request for playback of pictures of the received video stream, the request for playback corresponding to a normal playback operation or a given trick mode operation, the VSRP device interprets the RPRC and modifies the associations between reference pictures to ascending indices of a reference picture list for a decodable picture (e.g., of a given tier, explained below) and processes the picture according to the modified associations. Note that the term “reordered associations” or the like throughout the specification is equivalent to the term “modified associations of reference pictures of the DPB to ascending reference indices” according to one or more RPRCs. Note that reference herein to the phrase “pictures in a DPB” may assume the anticipated situation or instance of time when decodable pictures actually reside in the DPB according to decoding processing as set forth below.

In one embodiment, a first set of one or more RPRCs corresponding to a first picture of a video stream causes (e.g., during processing, such as decompression) the modification of associations of reference pictures of the DPB to ascending reference indices, and the decompression and reconstruction of the first picture is as intended (full reconstruction), as made possible by the modified reference indices for referencing pictures in the DPB correctly. During a trick mode, when the first picture of the video stream is processed, because some pictures that would be decoded during normal playback mode are not decoded, the first set of one or more RPRCs also result in the intended full reconstruction of the first picture.

One example tier framework is based on signaling pictures that belong to independently decodable sub-sequences that are intended to be used by a PVR application to fulfill or assist trick modes. In one embodiment, a hierarchy of data dependency tiers contains at most seven (7) tiers, though not limited to seven tiers in some embodiments (e.g., in some embodiments, may be more or less). A tier having a larger tier number is a “higher” tier than a tier having a smaller tier number. The tiers are ordered hierarchically from a lowest tier number (e.g., ‘1’ in some embodiments, though other values such as ‘0’ or otherwise may be used in some embodiments as a lowest tier number) to a highest tier number (e.g., ‘7’ in one example embodiment) based on their “decodability” so that any picture with a particular tier number does not depend directly or indirectly on any picture with a higher tier number. For instance, and using Tier 1 as the lowest tier (and “1” as the lowest tier number as one example), the first independently decodable sub-sequence contains pictures belonging exclusively to Tier 1. For all values of k from 2 to 6, independently decodable sub-sequence k is made up of the pictures in sub-sequence (k−1) plus the pictures belonging to Tier k. Herein, a Tier k picture is referred to as a picture signaled with a tier number equal to k, though in some embodiments, some pictures belonging to a given tier may not be signaled.

When decoding a video sequence that signals decodable sub-sequences for PVR assistance and/or fulfillment according to one or more tier frameworks, an AVC-compliant video decoder is able to provide normal playback of video (e.g., at 1× playback speed), yet may encounter a problem when using a decodable sub-sequence during trick mode operations (e.g., different than 1× playback speeds, such as greater than 1× playback speeds). One reason for the problem may be because the order of pictures in the reference picture list calculation (e.g., according to the AVC specification) that identifies its reference pictures may produce different results depending on a tier number of a picture being decoded. In other words, the macroblock-level reference indices provided with a referencing to a reference picture in the DPB may provide the proper reference picture identification during normal playback, but during a trick mode operation, such as a fast forward speed operation, the reference pictures contained in the DPB may be different as not all pictures in the video stream are decompressed. Consequently, reference indexing may refer to the incorrect reference pictures in the DPB during a trick mode, possibly causing either severe video artifacts or necessitating a PVR application to perform the necessary processing to determine the proper reference pictures for possibly all non-intra predicted pictures used during a trick mode operation.

Certain embodiments of PVRA systems avoid or mitigate this problem or shortcoming by requiring that the VSE (e.g., an encoder residing therein, though not limited to provision by the encoder) issue the RPRCs such that all reference pictures in the DPB that are referenced by a Tier k picture at its decoding time are referenced correctly, such as at the beginning of each reference picture list (i.e., be associated to lowest reference indices). In other words, in some embodiments, explicit reference picture reordering commands are employed in situations when a given compressed picture is desired to be decompressed and output during a first set of one or more trick modes, and that given picture refers to at least one reference picture that would not be indexed correctly with a derived default reference picture list List 0 or List 1. For instance, this would be the case when unmodified indices of the given picture (i.e., corresponding to the default associations of reference pictures to ascending reference pictures) contain at least one index which is greater in value than the reference index associated to a reference picture in a higher tier.

One or more RPRCs corresponding to the given picture have the effect of shifting, modifying, or reordering all the reference pictures in the reference picture list that are referenced by the current given picture. In particular, pictures with lower tier numbers are associated with the lowest reference indices and precede the reference indices associated with reference pictures in the DPB that have higher tier numbers. A set of one or more RPRCs may respectively correspond to L0 and L1. For some pictures, because of the slice (or picture) type, the tier number of the picture, or the referencing of pictures in the default reference picture list, RPRCs for only one of the lists is needed. This ensures that higher tiers are not required to be decoded for the given picture during a trick mode and that the reference indices of the given picture reference the correct reference pictures in the DPB. In one embodiment, changes to the reference picture list(s) while decoding the lower tier picture is to place higher tier number pictures at the end of the reference picture list rather than creating a situation where a macroblock in the given picture would reference the wrong picture or a non-existing picture with a high reference index during a trick mode (i.e., it avoids indexing a different-than-intended or nonexistent reference picture).

Certain embodiments of PVRA systems are described hereinafter in the context of an example subscriber television system environment, with the understanding that other multi-media (e.g., video, graphics, audio, and/or data) environments, including Internet Protocol Television (IPTV) network environments, cellular phone environments, and/or hybrids of these and/or other networks, may also benefit from certain embodiments of the PVRA systems and methods and hence are contemplated to be within the scope of the disclosure. It should be understood by one having ordinary skill in the art that, though specifics for one or more embodiments are disclosed herein, such specifics as described are not necessarily part of every embodiment. Note that reference herein to the term “picture” also contemplates a frame or access unit, and hence such terms may be used herein interchangeably except where differences in their intended meaning are explicitly distinguished. Further, MPEG-2 transport provisioned to carry H.264 video streams (per ISO 13818-1:2007 MPEG-2 Systems) is contemplated as a transport mechanism used in one or more PVRA system and method embodiments.

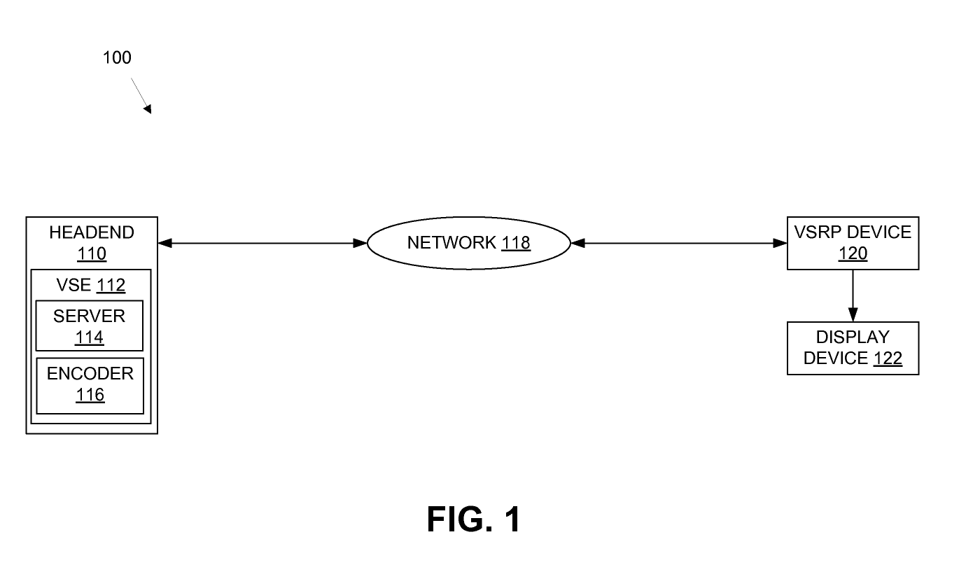

FIG. 1 is a high-level block diagram depicting an example environment in which one or more embodiments of PVRA systems are implemented. In particular, FIG. 1 is a block diagram that depicts an example subscriber television system (STS) 100. In this example, the STS 100 includes a headend 110 and one or more video stream receive-and-process (VSRP) devices 120 (one shown). The VSRP device 120 and the headend 110 are coupled via a network 118. The headend 110 and the VSRP device 120 cooperate to provide a user with television services, including, for example, broadcast television programming, interactive program guide (IPG) services, video-on-demand (VOD), and pay-per-view, as well as other digital services such as PVR, music, Internet access, commerce (e.g., home-shopping), voice-over-IP (VoIP), and/or other telephone or data services.

The VSRP device 120 is typically situated at a user's residence or place of business and may be a stand-alone unit or integrated into another device such as, for example, the display device 122, a personal computer, personal digital assistant (PDA), mobile phone, among other devices. In other words, the VSRP device 120 (which also may be referred to as a digital receiver, processing device, or digital home communications terminal (DHCT)) may comprise one of many devices or a combination of devices, such as a set-top box, television with communication capabilities, cellular phone, PDA, or other computer or computer-based device or system, such as a laptop, personal computer, DVD/CD recorder, among others. As set forth above, the VSRP device 120 may be coupled to the display device 122 (e.g., computer monitor, television set, etc.), or in some embodiments, may comprise an integrated display (with or without an integrated audio component).

The VSRP device 120 receives signals (video, audio and/or other data) including, for example, digital video signals in a compressed representation of a digitized video signal such as, for example, AVC streams modulated on a carrier signal, and/or analog information modulated on a carrier signal, among others, from the headend 110 through the network 118, and provides reverse information to the headend 110 through the network 118. The VSRP device 120 comprises, among other components, a coupled storage device (e.g., DVD recorder and/or player, CD recorder and/or player, etc.), as explained further below.

The television services are presented via the display device 122, which typically comprises a television set that, according to its type, is driven with an interlaced scan video signal or a progressive scan video signal. However, the display device 122 may also be any other device capable of displaying video images including, for example, a computer monitor, a mobile phone, game device, etc. In one embodiment, the display device 122 is configured with an audio component (e.g., speakers), whereas in some embodiments, audio functionality may be provided by a device that is separate yet communicatively coupled to the display device 122 and/or VSRP device 120. Although shown communicating with the display device 122, the VSRP device 120 may communicate with other devices that receive, store, and/or process video streams from the VSRP device 120, or that provide or transmit video streams or uncompressed video signals to the VSRP device 120.

The network 118 may comprise a single network, or a combination of networks (e.g., local and/or wide area networks). Further, the communications medium(s) of the network 118 may comprise a wired connection or wireless connection (e.g., satellite, terrestrial, wireless LAN, etc.), or a combination of both. In the case of wired implementations, the network 118 may comprise a hybrid-fiber coaxial (HFC) medium, coaxial, optical, twisted pair, etc. Other networks are contemplated to be within the scope of the disclosure, including networks that use packets incorporated with and/or compliant to MPEG-2 transport and/or other transport layers or protocols.

The headend 110 may receive content from sources external to the headend 110 or STS 100 via a wired and/or wireless connection (e.g., satellite or terrestrial network), such as from content providers, and in some embodiments, may receive package-selected national or regional content with local programming (e.g., including local advertising) for delivery to subscribers.

The headend 110 includes a video stream emitter (VSE) 112. The VSE 112 provides a compressed video stream (e.g., in a transport stream) to the VSRP device 120 (or in some implementations, to an intermediary device). The VSE 112 may include one or more server devices (server) 114 (one shown) for providing video, audio, and other types of media or data to client devices such as, for example, the VSRP device 120, and one or more encoders (encoding devices or compression engines) 116 (one shown). The encoder 116 may compress an inputted video signal (e.g., provided by a service provider in one of any of several forms, image capture device, a headend server, etc.) according to the specification of the AVC standard and produce an AVC stream containing different types of compressed pictures, some that may have a first compressed portion that depends on a first reference picture for their decompression and reconstruction, and a second compressed portion of the same picture that depends on a second and different reference picture. Since the compressed video (and audio) streams are produced in accordance with the syntax and semantics of a designated video (and audio) coding method, such as, for example, AVC, the compressed video (and audio) streams can be interpreted by an AVC-compliant decoder for decompression and reconstruction at the time of reception, at a future time, or both. Further description of an embodiment of the encoder 116 is described below.

In one embodiment, each AVC stream is packetized into transport packets according to the syntax and semantics of transport specification, such as, for example, MPEG-2 transport defined in MPEG-2 systems. Each transport packet contains a header with a unique packet identification code, or PID, associated with the respective AVC stream. In one implementation, encoded audio-video (A/V) content for a single program may be the only program carried in a transport stream (e.g., one or more packetized elementary stream (PES) packet streams sharing a common time base), and in other implementations, the encoded A/V content for multiple programs may be carried as multiplexed programs in an MPEG-2 transport stream, each program associated with its own respective time base.

In IPTV embodiments, the program or transport stream may be further encapsulated in Internet protocol (IP) packets, and delivered via multicast (e.g., according to protocols based on Internet Group Management Protocol (IGMP), among other protocols), or in other cases such as video-on-demand (VOD), via unicast (e.g., Real-time Streaming Protocol or RTSP, among other protocols). For instance, multicast may be used to provide multiple user programs destined for many different subscribers. Communication of IP packets between the headend 110 and the VSRP device 120 may be implemented according to one or more of a plurality of different protocols or communication mechanisms, such as User Datagram Protocol (UDP)/IP, Transmission Control Protocol (TCP)/IP, transport packets encapsulated directly within UDP or Real-time Transport Protocol (RTP) packets, among others.

One having ordinary skill in the art should understand that the headend 110 may comprise one or more additional servers (Internet Service Provider (ISP) facility servers, private servers, on-demand servers, channel change servers, multi-media messaging servers, program guide servers), splicers or splicing devices (e.g., for splicing in local feeds), modulators (e.g., QAM, QPSK, etc.), routers, bridges, gateways, multiplexers, transmitters, computers and/or controllers, and/or switches that process and deliver and/or forward (e.g., route) various digital services to subscribers.

The STS 100 may comprise an IPTV network, a cable television network, a satellite television network, or a combination of two or more of these networks or other networks. Further, network PVR and switched digital video are also considered to be within the scope of the disclosure. Although described in the context of video processing, it should be understood that certain embodiments of the PVRA systems described herein also include functionality for the processing of other media content such as compressed audio streams. The STS 100 comprises additional components and/or facilities not shown, as should be understood by one having ordinary skill in the art.

In one embodiment, a PVRA system comprises the headend 110 and the VSRP device 120. In some embodiments, a PVRA system comprises portions of each of these components, or in some embodiments, one of these components or a subset thereof. In some embodiments, one or more additional components described above yet not shown in FIG. 1 may be incorporated in a PVRA system, as should be understood by one having ordinary skill in the art in the context of the present disclosure.

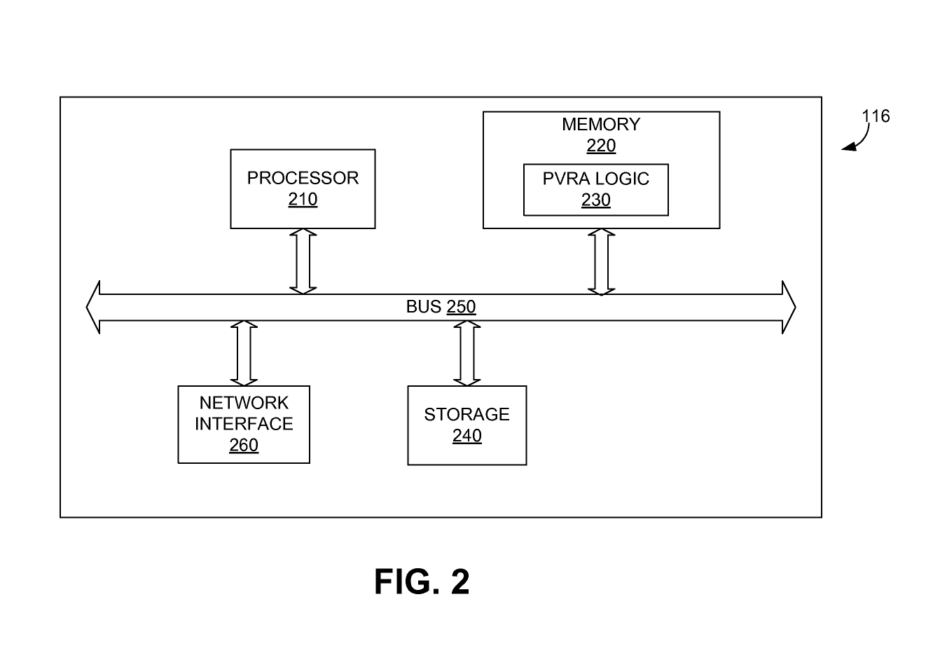

FIG. 2 is a block diagram of an example embodiment of an encoder 116 configured as a general purpose computer. It should be understood by one having ordinary skill in the art that the encoder 116 shown in FIG. 2 is merely illustrative, and should not be construed as implying any limitations upon the scope of the disclosure. The encoder 116 comprises a number of known components, including a processor 210, memory 220, a storage device 240, and a network interface 260 coupled to one or more busses 250 (one shown). Omitted from FIG. 2 are a number of conventional components that are unnecessary to explain the operation of the encoder 116. Shown residing in memory 220 is PVRA logic 230. The PVRA logic 230 comprises functionality to provide the reference picture index lists (e.g., L0 and/or L1), as well as the RPRCs, as well as including functionality to determine whether to issue the RPRCs respectively corresponding to each of a plural first type of compressed pictures, as explained further below, and according to the issued one or more RPRCs of a corresponding compressed picture, modify the reference indices associated with the required reference pictures needed to process the corresponding compressed picture.

The PVRA logic 230 can be implemented in software, hardware, or a combination of software and hardware. In some embodiments, such as that shown in FIG. 2, PVRA logic 230 is implemented in software, i.e., instructions retrieved from memory 220 for execution on a processor 210 (e.g., microprocessor, microcontroller, network processor, extensible processor, reconfigurable processor, etc.). In some embodiments, functionality of the PVRA logic 230 is implemented in hardware logic, including (but not limited to) a programmable logic device (PLD), a programmable gate array (PGA), a field programmable gate array (FPGA), an application-specific integrated circuit (ASIC), a system on chip (SoC), and a system in package (SiP).

It should be understood in the context of the present disclosure that functionality of the encoder 116 and/or PVRA logic 230 may reside in other locations of the STS 100 in some embodiments.

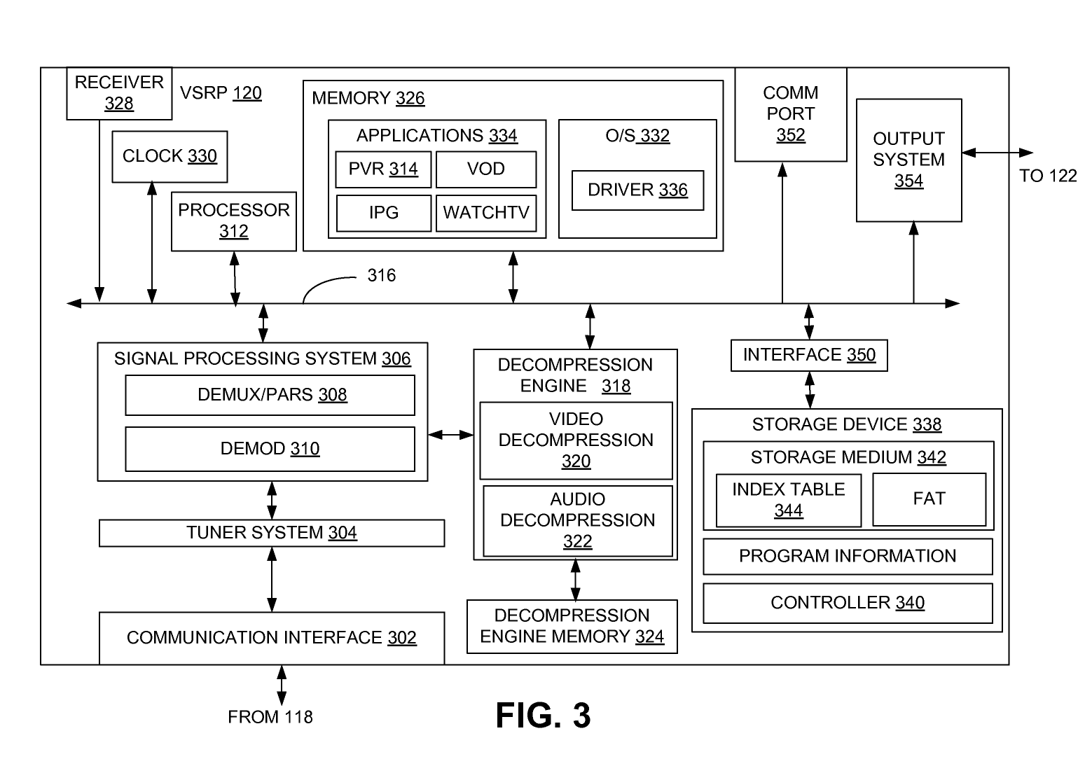

FIG. 3 is an example embodiment of select components of a VSRP device 120. It should be understood by one having ordinary skill in the art that the VSRP device 120 shown in FIG. 3 is merely illustrative, and should not be construed as implying any limitations upon the scope of the disclosure. In one embodiment, a PVRA system may comprise all components shown in, or described in association with, the VSRP device 120 of FIG. 3. In some embodiments, a PVRA system may comprise fewer components, such as those limited to facilitating and implementing PVR functionality, the decoding of compressed video streams, and/or output processing of decompressed video streams. In some embodiments, functionality of the PVRA system may be distributed among the VSRP device 120 and one or more additional devices as mentioned above.

The VSRP device 120 includes a communication interface 302 (e.g., depending on the implementation, suitable for coupling to the Internet, a coaxial cable network, an HFC network, satellite network, terrestrial network, cellular network, etc.) coupled in one embodiment to a tuner system 304. The tuner system 304 includes one or more tuners for receiving downloaded (or transmitted) media content. The tuner system 304 can select from among a plurality of transmission signals provided by the STS 100 (FIG. 1). The tuner system 304 enables the VSRP device 120 to tune to downstream media and data transmissions, thereby allowing a user to receive digital media content via the STS 100. In one embodiment, analog TV signals can be received via the tuner system 304. The tuner system 304 includes, in one implementation, an out-of-band tuner for bi-directional data communication and one or more tuners (in-band) for receiving television signals. In some embodiments (e.g., IPTV-configured VSRP devices), the tuner system 304 may be omitted.

The tuner system 304 is coupled to a signal processing system 306 that in one embodiment comprises a transport demultiplexing/parsing system 308 (demux/pars, or hereinafter, demux) and a demodulating system 310 for processing broadcast and/or on-demand media content and/or data. One or more of the components of the signal processing system 306 may be implemented with software, a combination of software and hardware, or in hardware. The demodulating system 310 comprises functionality for demodulating analog or digital transmission signals.

The components of the signal processing system 306 are generally capable of QAM demodulation (though in some embodiments, other modulation formats may be processed such as QPSK, etc.), forward error correction, demultiplexing of MPEG-2 transport streams, and parsing of packets and streams. The signal processing system 306 has capabilities, such as filters, to detect bit patterns corresponding to fields in the transport packet's header information, adaptation field, and/or payload. Stream parsing may include parsing of packetized elementary streams or elementary streams. Packet parsing may include parsing and processing of data fields, such as the data fields in the adaptation fields in the transport packets that deliver tier information, among other information, corresponding to one or more of the compressed pictures corresponding to a program in an AVC stream. In some embodiments, tier information may be provided according to alternative mechanisms, such as in auxiliary information, in bitmaps at select locations of a video stream, etc.

In one embodiment, the parsing is performed by the signal processing system 306 (e.g., demux 308) extracting the information and one or more processors 312 (one shown) processing and interpreting the tier information (e.g., the tier number of its associated picture) and the RPRCs. In some embodiments, the processor 312 performs the parsing, processing, and interpretation. The signal processing system 306 further communicates with the processor 312 via interrupt and messaging capabilities of the VSRP device 120.

Concurrently, the signal processing system 306 precludes further processing of packets in the multiplexed transport stream that are irrelevant or not desired, such as packets of data corresponding to other video streams. As indicated above, parsing capabilities of the signal processing system 306 allow for the ingesting by the VSRP device 120 of program associated information carried in the transport packets. The demux 308 is configured to identify and extract information in the transport stream to facilitate the identification, extraction, and processing of the compressed pictures. Such information includes Program Specific Information (PSI) (e.g., Program Map Table (PMT), Program Association Table (PAT), etc.) and parameters or syntactic elements (e.g., Program Clock Reference (PCR), time stamp information, payload_unit_start_indicator, etc.) of the transport stream (including packetized elementary stream (PES) packet information). For instance, in some embodiments, a flag, field, or other indicator may be provided in the transport stream (e.g., adaptation field of one or more transport packets) that indicates to the decoding logic (or other components of the VSRP device 120, such as PVR application 314, etc.) that the video stream includes modify commands (e.g., RPRC) for reference picture list(s).

In one embodiment, information extracted by the demux 308 may include information to determine or derive the reference picture lists L0 and/or L1, RPRCs, tier information, among other information. In general, information extracted by the demux 308 may include information that assists PVR logic embodied in one embodiment as PVR application 314, as explained further below. Note that in some embodiments, the PVR application 314 may opt to disregard or modify the received information. In some embodiments, portions of the information (e.g., tier number) may not be transmitted for defined periods of time of a program, or for portions of a video stream, such as portions corresponding to a commercial.

In an alternate embodiment, information to determine or derive the reference picture lists L0 and/or L1, and RPRCs, is extracted from the video stream and processed by decompression engine 318. In yet another embodiment, information to determine or derive the reference picture lists L0 and/or L1, and RPRCs, is extracted from the video stream and processed by processor 312. And in yet another embodiment, information to determine or derive the reference picture lists L0 and/or L1, and RPRCs, is extracted from the video stream by decompression engine 318 and interpreted by processor 312.

In one embodiment, the demux 308 is configured with programmable hardware (e.g., PES packet filters). In some embodiments, the signal processing system 306 or one or more components thereof is configured in software, hardware, or a combination of hardware and software.

The signal processing system 306 is coupled to one or more busses (a single bus 316 is shown) and to decoding logic configured in one embodiment as a decompression engine 318 (or media engine). In some embodiments, reference to decoding logic may include one or more additional components, such as memory, processor 312, etc. The decompression engine 318 comprises a video decompression engine 320 (or video decoder or video decompression logic) and audio decompression engine 322 (or audio decoder or audio decompression logic). The decompression engine 318 is further coupled to decompression engine memory 324 (or media memory or memory), the latter which, in one embodiment, comprises one or more respective buffers for temporarily storing compressed (compressed picture buffer or bit buffer, not shown) and/or reconstructed pictures (decoded picture buffer or DPB). In some embodiments, one or more of the buffers of the decompression engine memory 324 may reside in whole or in part in other or additional memory (e.g., memory 326) or components.

The VSRP device 120 further comprises additional components coupled to the bus 316. For instance, the VSRP device 120 further comprises a receiver 328 (e.g., infrared (IR), radio frequency (RF), etc.) configured to receive user input (e.g., via direct-physical or wireless connection via a keyboard, remote control, voice activation, etc.) to convey a user's request or command (e.g., for program selection, stream manipulation such as fast forward, rewind, pause, channel change, etc.), the processor 312 (indicated above) for controlling operations of the VSRP device 120, and a clock circuit 330 comprising phase and/or frequency locked-loop circuitry to lock into a system time clock (STC) from a program clock reference, or PCR, received in the video stream to facilitate decoding and output operations.

For instance, time stamp information (e.g., presentation time stamp/decode time stamp, or PTS/DTS) in the received video stream is compared to the reconstructed system time clock (STC) (generated by the clock circuit 330) to enable a determination of when the buffered compressed pictures are provided to the video decompression engine 320 for decoding (DTS) and when the buffered, decoded pictures are output by the video decompression engine 320 according to their PTS via the output system 354. The output system 354 hence may comprise graphics and display pipelines and output logic including HDMI, DENC, or other known systems. In some embodiments, the clock circuit 330 may comprise plural (e.g., independent or dependent) circuits for respective video and audio decoding operations and output processing operations. Although described in the context of hardware circuitry, some embodiments of the clock circuit 330 may be configured as software (e.g., virtual clocks) or a combination of hardware and software.

The VSRP device 120 further comprises memory 326, which comprises volatile and/or non-volatile memory, and is configured to store executable instructions or code associated with an operating system (O/S) 332, one or more other applications 334 (e.g., the PVR application 314, interactive programming guide (IPG), video-on-demand (VOD), WatchTV (associated with broadcast network TV), among other applications not shown such as pay-per-view, music, etc.), and driver software 336.

The VSRP device 120 further comprises one or more storage devices (one shown, storage device 338). The storage device 338 may be located internal to the VSRP device 120 and coupled to the bus 316 through a communication interface 350. The communication interface 350 may include an integrated drive electronics (IDE), small computer system interface (SCSI), IEEE-1394 or universal serial bus (USB), among others. In one embodiment, the storage device 338 comprises associated control logic, such as a controller 340, that in coordination with one or more associated drivers 336 effects the temporary storage of buffered media content and/or more permanent storage of recorded media content. Herein, references to write and/or read operations to the storage device 338 is understood to refer to write and/or read operations to/from one or more storage mediums of the storage device 338.

The device driver 336 is generally a software module interfaced with and/or residing in the operating system 332. The device driver 336, under management of the operating system 332, communicates with the storage device controller 340 to provide the operating instructions for the storage device 338. As conventional device drivers and device controllers are well known to those of ordinary skill in the art, further discussion of the detailed working of each will not be described further here. The storage device 338 may further comprise one or more storage mediums 342 such as hard disk, optical disk, or other types of mediums, and an index table 344, among other components (e.g., FAT, program information, etc.) as should be understood by one having ordinary skill in the art. In some embodiments, the storage device 338 may be configured as non-volatile memory or other permanent memory.

In one implementation, video streams are received in the VSRP device 120 via communications interface 302 and stored in a temporary memory cache (not shown). The temporary memory cache may be a designated section of memory 326 or an independent memory attached directly, or as part of a component in the VSRP device 120. The temporary cache is implemented and managed to enable media content transfers to the storage device 338 (e.g., the processor 312 causes the transport stream in memory 326 to be transferred to a storage device 338). In some implementations, the fast access time and high data transfer rate characteristics of the storage device 338 enable media content to be read from the temporary cache and written to the storage device 338 in a sufficiently fast manner. Multiple simultaneous data transfer operations may be implemented so that while data is being transferred from the temporary cache to the storage device 338, additional data may be received and stored in the temporary cache.

Alternatively or additionally, the storage device 338 may be externally connected to the VSRP device 120 via a communication port, such as communication port 352. The communication port 352 may be configured according to IEEE-1394, USB, SCSI, or IDE, among others. The communications port 352 (or ports) may be configured for other purposes, such as for receiving information from and/or transmitting information to devices other than an externally-coupled storage device.

With regard to processing of tier information (e.g., tier number), the processor 312, alone or in conjunction with other VSRP components, interprets the tier information received (in one embodiment) in the transport stream and produces annotations associated with the respective tier number corresponding to a video program to fulfill or enhance PVR functionality provided to an end user, such as trick modes. For instance, the signal processing system 306 parses (e.g., reads and interprets) transport packets, and deposits the information corresponding to the tier information for each picture in memory 326. Note that the signal processing system 306 can parse the received transport stream (or a program stream in some embodiments) without disturbing its video stream content and deposit the parsed transport stream (or program stream) into memory 326. The processor 312 may generate the annotations even if the video program is encrypted because the tier information is carried unencrypted since the adaptation field of transport packets is unencrypted. Note that additional relevant security, authorization and/or encryption information may be stored.

As the AVC stream is received and stored in storage device 338, the processor 312 annotates the location of pictures within the AVC stream as well as other pertinent information (e.g., tier information, default reference picture lists, RPRCs, etc.) corresponding to each picture when present. Alternatively or additionally, the annotations may be according to or derived, at least in part, from the tier information. For instance, the processor 312 receives the tier information parsed from the transport stream, and then determines based on the tier information to which tier the corresponding picture belongs. The processor 312 may annotate the received pictures with the associated tier number for later use in decode operations. For instance, the processor 312 may generate ancillary data in the form of a table or data structure (e.g., index table 344) comprising the relative or absolute location of the beginning of certain pictures in the compressed video stream and also makes annotations for PVR operations. The annotations produced by the processor 312 may be stored in storage device 338 to enable normal playback as well as other playback modes of the stored instance of the AVC stream. In some embodiments, the annotations may be stored elsewhere.

In one embodiment, as indicated above, the processor 312 annotates the location of pictures within the video stream or transport stream as well as other pertinent information corresponding to the video stream based in one embodiment on the reception and interpretation of tier information. Thus, the pictures may be sorted-out based on tiers. The annotations by the processor 312 enable normal playback as well as other playback modes of the stored instance of the video program. Other playback modes, often referred to as “trick modes,” may comprise backward or reverse playback, forward playback, or pause or still. Each of the different playback modes may require the decoding of a given sub-sequence of pictures uniquely pertaining to pictures of a given tier (tier number) or a combination of different tiers, depending on the desired (e.g., user-invoked or machine-invoked) stream manipulation.

The playback modes may comprise one or more playback speeds other than the normal playback speed. A trick mode may be characterized by: (1) its speed as a multiplicative factor in relation to the speed of the normal playback mode, and (2) its direction, either forward or reverse. Some playback speeds may be slower than normal speed and others may be faster. Faster playback speeds may constitute speeds considered very fast (e.g., greater than three times normal playback speed), as determined by a threshold, and critical faster speeds (e.g., greater than normal playback speed but not above the threshold). This threshold can be referred to as the critical fast-speed threshold. In one embodiment, the critical fast-speed threshold is further influenced by the picture rate implemented by the output system 354 to output the video signal corresponding to decompressed version of the pictures of the AVC stream to the display device 122. In some embodiments, the basis is further determined on whether the output system 354 is providing a progressive or interlaced video signal to the display device 122. Then, for a given stream manipulation, such as fast forward, the knowledge of these different tiers (e.g., as annotated in a storage device) can be used, for instance, to drop pictures and still be assured that all picture references are satisfied.

In one embodiment, the tier information of each compressed picture in the AVC stream is provided to the decompression engine 318 by the processor 312 as the AVC stream is received and processed in VSRP device 120. In some embodiments, the tier information (e.g., associated with the annotations) stored in the storage device 338 is provided to the decompression engine 318 by the processor 312 during playback of a trick mode. In some embodiments, the tier information for each compressed picture (or sets of compressed pictures in some embodiments), as well as relevant annotation information that may be necessary, are only provided to the decompression engine 318 during a trick mode, wherein the processor 312 has programmed the decompression engine 318 to perform trick modes.

In some embodiments, the tier information may be processed by other network components (not shown) in the subscriber television system 100. For instance, such network components may have the capability to process and interpret transport packets for the purpose of performing or fulfilling a certain functionality required for a video service or an application. Such network components may perform a particular stream manipulation operation based on the tier information, if any, corresponding to the respective compressed pictures, preferably doing so without parsing or decompressing the AVC stream or with a reduced amount of parsing, interpretation, and/or decompression of the AVC stream.

One having ordinary skill in the art should understand that the VSRP device 120 may include other components not shown, including compression engine, decryptors, samplers, digitizers (e.g., analog-to-digital converters), multiplexers, conditional access processor and/or application software, Internet browser, among others. In some embodiments, functionality for one or more of the components illustrated in, or described in association with, FIG. 3 may be combined with another component into a single integrated component or device or distributed among several components or devices.

The PVRA system may comprise the entirety of the VSRP device 120 in one embodiment, the VSE 112 in some embodiments, or a combination of both components in certain embodiments. In some embodiments, the PVRA system may comprise or one or more components or sub-components thereof, or additional components not shown. The PVRA system may be implemented in hardware, software, firmware, or a combination thereof. To the extent certain embodiments of the PVRA system or a portion thereof are implemented in software or firmware, executable instructions for performing one or more tasks of the PVRA system are stored in memory or any other suitable computer readable medium and executed by a suitable instruction execution system. In the context of this document, a computer readable medium is an electronic, magnetic, optical, or other physical device or means that can contain or store a computer program for use by or in connection with a computer related system or method.

To the extent certain embodiments of the PVRA system or portions thereof are implemented in hardware, the PVRA system may be implemented with any or a combination of the following technologies, which are all well known in the art: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

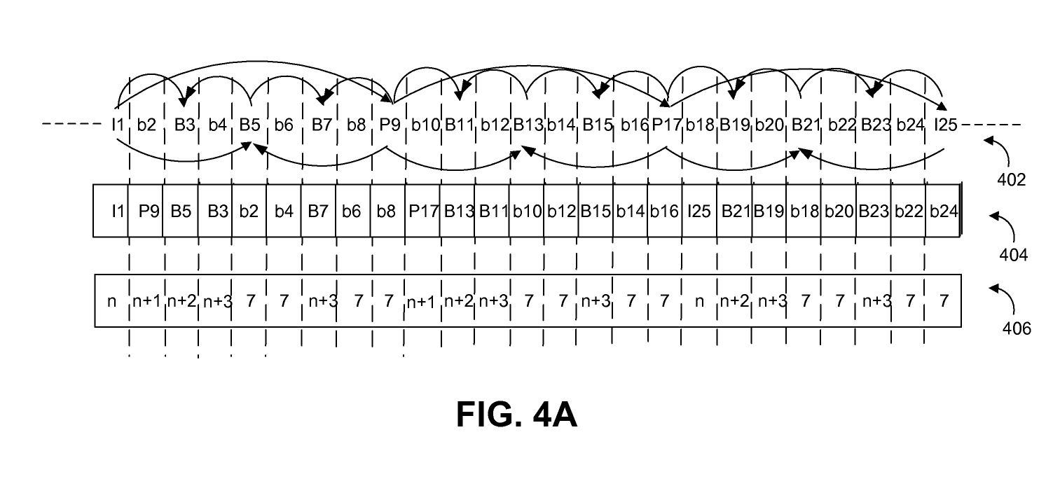

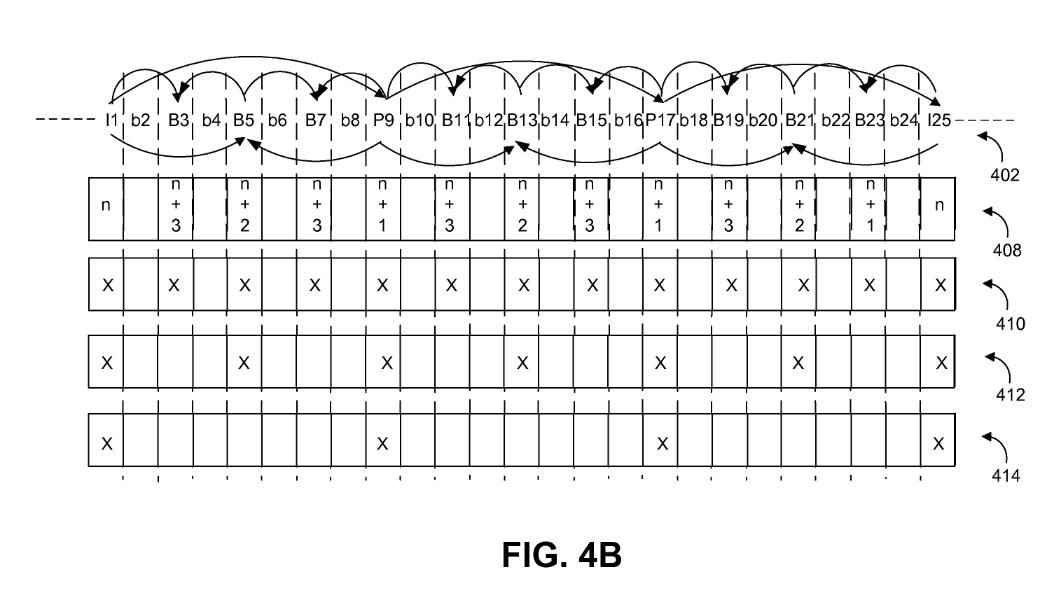

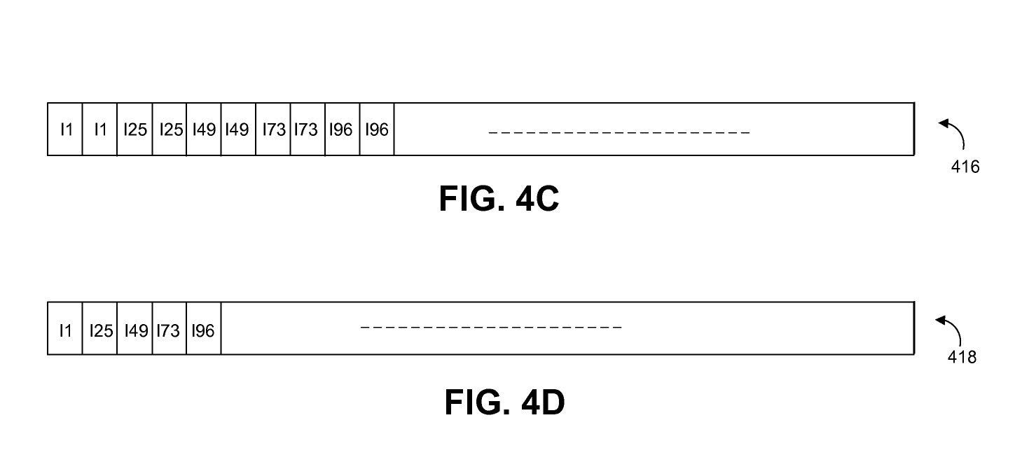

Having described some example devices and respective components that make up certain embodiments of PVRA systems, attention is directed to FIGS. 4A-4D for illustrating trick modes based on tier number. In particular, FIG. 4A is a block diagram that illustrates an example relationship between picture interdependencies and tiers (and corresponding tier numbers or symbols thereof), and FIGS. 4B-4D illustrate some example decodable sub-sequences corresponding to implementation of certain example trick modes based on tier number. It should be understood that AVC/H.264 picture types and interdependencies are contemplated to be within the scope of the PVRA system and method embodiments.

The first row 402 comprises one picture interdependency scheme (e.g., in display order), with letters I, P, and B (and b) corresponding to respective picture types (e.g., “I” corresponding to an Intra-coded picture or an Instantaneous Decode Refresh (IDR) picture, etc.), and the arrowhead lines pertaining to the picture interdependencies. For example, I1 serves as a reference picture to and predicts B3 and P9, B5 predicts B3 and B7, and each picture pointed to by a respective arrow would have at least one reference index in its compressed picture form to the reference picture at the tail of that arrow. Arrowheads corresponding to picture interdependencies involving some picture types (e.g., b2, b4, and other Tier 7 pictures, explained below) are omitted from this diagram to avoid unduly complicating the diagram (though in some embodiments, the highest tier number may not be signaled). The dashed lines on each side of row 402 are intended to convey that the sequence of pictures shown in FIG. 4A may be a continuum of a larger video stream (or larger sequence). Accordingly, it should be understood that the sequence shown in FIG. 4A is for illustrative purposes, and not intended to be limiting.

Row 404 shows one example sequence of pictures in decode or transmission order corresponding to the pictures illustrated in row 402. It is noted that the video stream in decode order may have other pictures between I1 and P9. Row 406 shows example tier numbers corresponding to the five (5) tier levels shown in correspondence with the pictures of row 404, including a lowest tier number “n,” to a next higher tier number “n+1,” and then to a next higher tier number “n+2”, ending in a highest tier number using, for exemplary non-limiting purposes, seven (7). In one embodiment, all the I and IDR pictures are exclusively assigned the lowest tier number, such as tier 1. As shown collectively from rows 404 and 406, the I pictures of the picture sequence shown in row 404 are signaled as tier n pictures, the forward predicted “P” pictures are signaled as tier n+1 pictures, the “B” pictures predicted exclusively from the “P” and “I” pictures are signaled as tier n+2 pictures, and the other “b” pictures are signaled as Tier 7 pictures. The lower case represents a picture that is discardable (i.e., not used as a reference picture and thus not referenced by any other picture and not included in the associations of reference pictures to ascending reference indices of reference picture lists).

Referring to FIG. 4B, row 402 again illustrates the interdependencies as shown in row 402 of FIG. 4A, yet illustrates the tier numbers signaled in every other picture, which are tiers n through n+3 as shown in row 408 (display order). A wide range of playback speeds are possible from tier n pictures only (e.g., very fast) to higher tier numbers. Assume below for illustrative, non-limiting purposes, a tier numbering scheme where ‘1’ (of Tier 1) is the lowest tier number and ‘7’ (of Tier 7) is the highest tier number. The PVR application 314 may provide alternate speeds with the pictures in Tiers 1 to (k−1) and a portion of the pictures in Tier k. In some cases, the display of some pictures may be repeated to avoid burdening the decoding logic beyond its capabilities; in other cases, to maintain speed accuracy. In one embodiment, the tier number of a picture is not signaled if it causes the decoding logic to process pictures faster than a speed of 1×. In FIG. 4B, row 410 corresponds to a trick mode having a 2× playback speed that is rendered by decoding every other picture (as denoted by the “X” in every other block that corresponds (column-wise) to every other tier number or picture).

In one embodiment, the number of pictures signaled from Tiers 1 through k is approximately half the number of pictures per every consecutive one (1.0) second interval of the video stream, and the pictures are evenly spread to provide a smooth 2× trick mode. The complementary fields PVR_assist_tier_cumulative_frames' and PVR_assist_tier_n′ may be signaled for this purpose. One premise for a tier framework is that if a sufficient number of pictures are provided to fulfill a smooth, 2× playback, then there may be a sufficient number of pictures to also render smooth playback of speeds higher than 2×. For example, if thirty (30) of every sixty (60) pictures per second are signaled with Tiers 1 to k with these complementary fields, then it is possible to provide a 2× playback of sixty (60) pictures per second from the thirty (30) signaled pictures in every one (1.0) second interval, or equivalently, sixty (60) signaled pictures may be decoded for every two (2.0) second interval. Likewise, smooth 4× playback may be fulfilled with fifteen (15) of the signaled pictures in every one (1.0) second interval.

In some cases, the PVR application 314 may render a 2× playback speed by decoding the pictures in Tiers 1 to 3 and repeating the output of each picture once.

Tier numbers may be used to signal discardable pictures, or different categories of discardable pictures. For instance, with an MPEG-2-like group of pictures (GOP), or other types of sequences or patterns, having three (3) B pictures between reference pictures, the middle B picture of every trio may be signaled as a Tier 6 picture and the other two as Tier 7 pictures, which facilitates retention of the temporal sampling of the video when pictures need to be discarded.

In one embodiment, for all values of k from 1 to 6, a Tier k picture after a random access point (RAP) is decodable and fully reconstructable if the respective tier number is signaled for each and every picture belonging to Tiers 1 through k that are located between the Tier k picture's decodable entry point (DEP) and the Tier k picture.

Referring again to FIG. 4B for examples of other trick modes corresponding to additional playback speeds (and returning to using the nomenclature where n is the lowest tier number), row 412 corresponds to an example independently decodable sub-sequence of pictures in tier n through tier n+2 (e.g., includes pictures stored in the storage device 338 and each annotated as either tier n, tier n+1, or tier n+2 based, for instance, on signaling from the headend 110) based on a request for a 4× playback speed corresponding to another trick mode, whereby the request causes the retrieval and subsequent decoding and output of the corresponding tier pictures.

Row 414 corresponds to an example independently decodable sub-sequence of pictures in tier n through tier n+1 based on a request for an 8× playback speed corresponding to yet another trick mode.

FIGS. 4C and 4D show some example decodable sub-sequences that consist entirely of I pictures to enable in some embodiments even higher playback speeds (for a desired trick mode) than those illustrated in FIG. 4B. For instance, row 416 shows one implementation whereby I pictures across many GOPs (or other segments or patterns) may be repeated (e.g., once per I picture in this example) to achieve a trick mode corresponding to a 12× playback as shown in FIG. 4C. FIG. 4D illustrates the selection of each I picture that begins and ends a given GOP (e.g., segment or pattern) across plural GOPs to achieve a trick mode corresponding to a 24× playback speed, as shown in row 418. Variations to these implementations are contemplated to be within the scope of the PVRA embodiments.

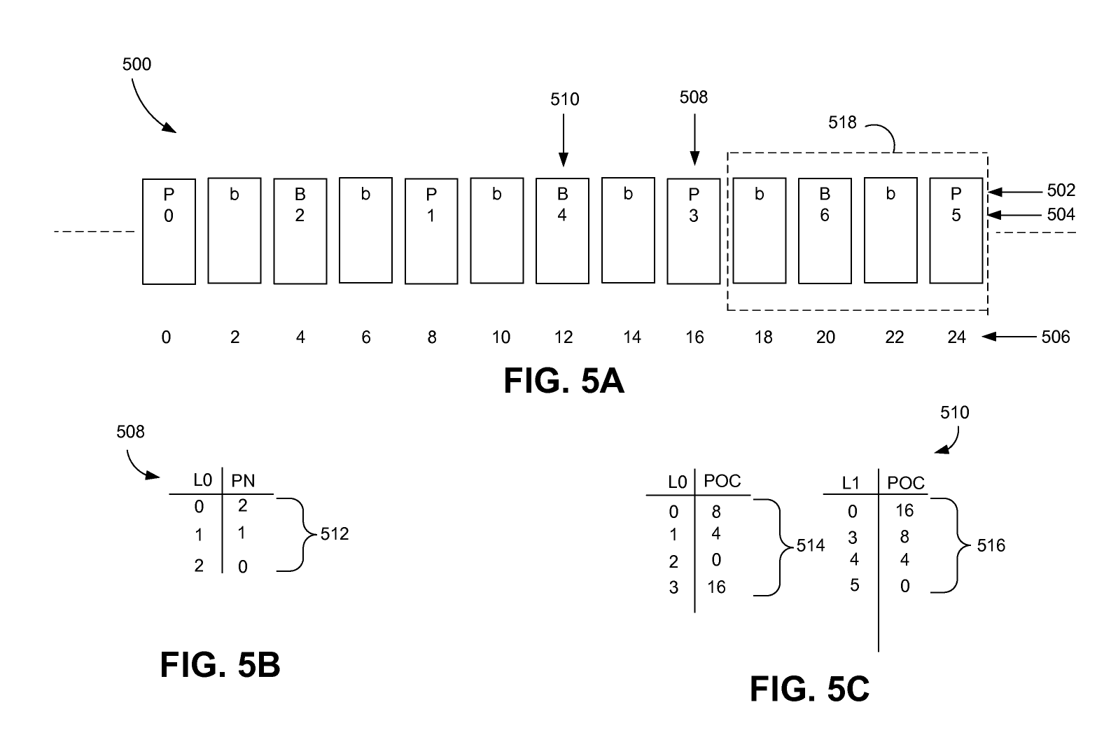

Having described the use of tiers in the context of PVR functionality, attention is directed to an explanation of default reference picture lists as shown in FIGS. 5A-5C, consistent with the manner of DPB processing for an AVC-compliant decoder. Referring to FIG. 5A, shown is a sequence of pictures 500, with each picture comprising a picture type 502, and each reference picture (denoted with upper case picture types) comprising a frame or picture number (PN) 504. Also shown is a picture order count (POC) 506 corresponding to each picture. FIGS. 5B and 5C illustrate example reference picture list 0 (hereinafter, also referred to simply as L0) corresponding to currently decoded picture 508 (a P picture) and reference picture lists, L0 and L1 (hereinafter, also simply L0 and L1) corresponding to currently decoded picture 510 (a B picture). In one embodiment, the PVRA logic 230 is configured to provide L0 and L1 in accordance with the AVC specification. In general, the default association of ascending reference indices to reference pictures in the DPB is in accordance to a respectively corresponding sorting of the reference pictures for a given type of picture or frame. Thus, reference indices are determined (or derived) in one or two lists depending on the frame type. The sorting for association purposes also depends on the frame type.

In an alternate embodiment, sorting of associations of reference pictures in the DPB to ascending reference pictures may respectively correspond to a specific type of reference picture list among plural reference picture lists.

Referring to FIG. 5B, for P frames (e.g., P frame 508), there is only one reference picture list, L0 512, and each index is associated with a reference picture in the DPB determined based on the PN 502 of the previously decoded pictures, with reference index 0 being associated with the picture with the highest PN (e.g., the B picture with PN=2) below that of the current picture (and thus the reference picture in the DPB most recently decoded) and continuing in order of descending picture number (i.e., PN). Accordingly, the PN of previously decoded reference pictures includes those with a PN value equal to 1 (P picture) associated with index 1 and a PN value equal to 0 (P picture) associated with index 2. Stated differently, the indices in L0 512 are associated with the reference pictures in the DPB from the most recently decoded first to the earliest decoded.

For B frames (e.g., B frame 510), and now referring to FIG. 5C, the PVRA logic 230 generates two lists, L0 514 and L1 516, of reference indices, and their association to reference pictures in the DPB is based on the respective POC of previously decoded pictures. Whereas for P frames the sorting of pictures in L0 was in accordance to decode order and/or additionally by a parameter provided and corresponding to the picture, such as frame number, for B frames the sorting of pictures is according to their output order (i.e., POC) and/or additionally by a parameter provided and corresponding to the picture, such as picture order count (POC). The associations of L0 begin with the highest POC below that of the current picture (e.g., POC with a value of eight (8) corresponding to a P picture) and descending to the lowest POC in the DPB (e.g., P picture with a POC=0, which is subsequent in L0 514 to the B picture with a POC=4), followed by the lowest POC which is above that of the current picture (e.g., P picture with POC=16), and thus yet to be displayed, and ascending to the highest POC in the DPB. In this example, frames with POC values of eighteen (18) or higher are assumed to not yet have been decoded with respect to frames 508 and 510, as symbolically represented by the dashed box 518, thus L0 514 is as shown in FIG. 5C.

The associations of reference indices of L1 516 is according to the converse sorting or POC relativeness, beginning with the lowest POC which is above that of the current picture (e.g., P picture with POC=16) and ascending (e.g., since frames encompassed by dashed box 518 have not been decoded with respect to frames 508 and 510, no associations with the index for these pictures in 518 are shown), followed by the highest POC below that of the current picture (e.g., P picture with POC=8) and descending (e.g., B picture then P picture, with respective POC values of 4 and 0).

In one embodiment, the number of entries in L0 and L1 are limited by the syntax elements num_ref_idx_{—}10_active_minus1 and num_ref_idx_{—}11_active_minus1 respectively, from the slice header or picture parameter set associated with each picture.

Encoder-specified RPRCs enable (e.g., effects or causes) the VSRP device 120 to change the ordering of associations in each reference picture list from default associations (e.g., as shown in FIGS. 5A-5C) by specifying which PN should be associated with reference index 0, 1, and so on. In one embodiment, this reordering affects only the slice containing the reference picture reordering commands; the default picture order is recomputed for each slice. For purposes of discussion, it is assumed that each picture is coded as a single slice, with the understanding that there may be plural slices in a single picture (and if the picture contains plural slices, the RPRCs are issued in each slice as required). It is allowable for RPRCs to specify the same PN twice in the same list, meaning that the same frame can be indicated by more than one reference index. This may be useful for features such as weighted prediction which specify weighting information on a per-reference index basis. In other words, in some embodiments, one reference picture may have two associations, the associations each weighted according to one or more predetermined weights.

Decoding logic of the VSRP device 120 stores decoded pictures which are used for future reference or are awaiting display output in the DPB. Frames in the DPB are identified by picture number (PN) which is computed based on the frame number syntax element found in the picture's slice header. The frame number increases by one each time a reference picture is coded (or decoded from a decoder's perspective). Non-reference pictures have the same frame number as the last coded reference picture and can be readily identified. A non-reference pictures can enter the DPB when it has an output time later than its decode time. Some pictures in the DPB that were formerly reference pictures may be marked unused for reference once they cease serving as a reference picture. These pictures can be readily identified. A picture that is not a reference picture and has already been output is removed from the DPB according to the HRD management policies of the AVC specification and/or the MPEG-2 transport specification, ISO-13818-1: 2007, both herein incorporated by reference in their entirety.

In one embodiment, associations of decoded reference pictures to ascending indices of a reference picture list are reordered during video decoding in normal playback modes (i.e., 1× speed, non trick modes). For instance, a decoded picture buffer (DPB) may comprise reference pictures and non-reference pictures (e.g., the latter having a delayed output picture time), and at some instances of time, the reference pictures in the DPB may not serve as reference pictures to the currently decoded picture.

In some embodiments, associations are made to decoded pictures that are only reference pictures to the current picture being processed. Further, in some embodiments, reordering of associations to decoded pictures in the DPB is based on whether the reference picture serves as a reference picture to the currently decoded picture or not. For instance, where associations are implemented through one or more lists or tables, reordering comprises sorting associations such that decoded pictures that serve as reference pictures to the picture currently being decoded are located first in the list (i.e., they are associated with the lowest reference indices), and associations to decoded reference pictures not serving as reference pictures to the currently decoded picture are located last in the list. Note that the latter reference pictures correspond to pictures with a higher number tier than the tier number of the picture currently being decoded.

In one embodiment, the maximum allowed reference index to a reference picture list is lowered from a default value to correspond to the number of reference pictures used by the current picture minus one (i.e., since the first index is zero (0)). The RPRC works in concert with the lower maximum reference index for proper indexing of reference pictures during normal playback and trick modes.

In an alternate embodiment, a lowered index corresponds to the value for all reference pictures in the DPB with tier number lower or equal to the tier number of the current picture.

In some embodiments, for the two lists pertaining to B pictures (List 0 and List 1), a first type or method of sorting is implemented for List 0 and a second type or method of sorting is implemented for List 1.

In some embodiments, reordering is implemented for only one of the two lists, L0 and L1, or both. For instance, in one embodiment, a reordering command is issued (e.g., preemptively) to effect reordering of both lists, L0 and L1. In some embodiments, a reordering command is issued to effect reordering of only one of the lists.

Other variations are contemplated to be within the scope of the embodiments disclosed herein. For instance, in one embodiment, reordering of L0 is implemented for a first B picture, and later, reordering of L1 is implemented for a second B picture, and later, for a third B picture, reordering is implemented for both L0 and L1.

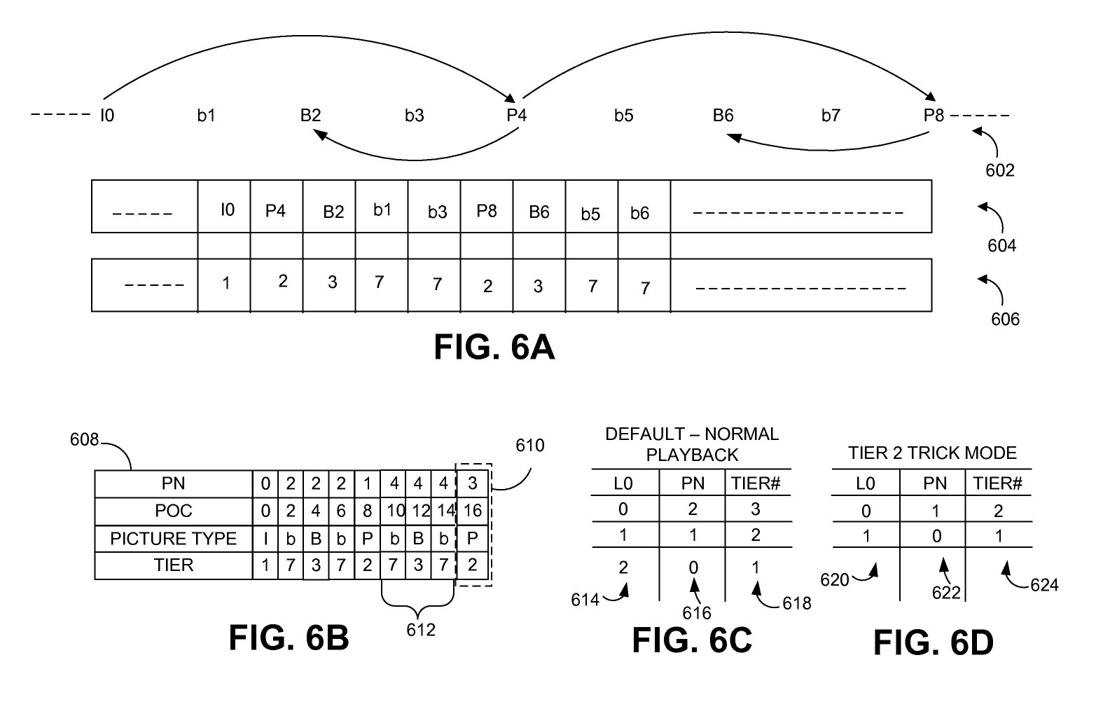

Attention is directed to the block diagrams of FIGS. 6A-8, which illustrate some example PVRA method embodiments. It should be understood by one having ordinary skill in the art that the picture sequences, picture interdependencies, and schemes shown in, and/or described in association with, FIGS. 6A-8 are merely illustrative, and should not be construed as implying any limitations upon the scope of the disclosure. For instance, FIGS. 6A-6D are block diagrams that illustrate an example sequence of pictures of a video stream and information associated with the provision of default and trick mode reference picture lists. In the interest of brevity and avoiding unduly complicating the discussion, one example generic picture sequence is presented and the reference picture lists are provided in the context of a currently decoded picture comprising a P picture (e.g., hence directed to reference picture list L0 and not L1), with the understanding that similar principles apply for other picture sequences, interdependencies, and currently decoded pictures of different types as should be appreciated by one having ordinary skill in the art in the context of the disclosure.

Referring to FIG. 6A, shown is an example picture sequence 602 that comprises a portion or segment (e.g., GOP) of a video stream. The continuity of the video stream (or segment) is represented by the dotted lines on each side of the picture sequence 602. Similar notation is used in this example as is used in FIG. 4A, except that an identifier of 0 (e.g., immediately adjacent to the first I picture shown in the sequence 602, or I0) instead of 1 (i.e., I1) is used to identify the picture that starts the sequence 602. The picture sequence 602 comprises one example picture interdependency scheme (e.g., in display order), with letters I, P, and B (and b) corresponding to respective picture types (e.g., “I” corresponding to an Intra-coded picture or an Instantaneous Decode Refresh (IDR) picture, etc.), and the arrowhead lines pertaining to the picture interdependencies. For example, I0 serves as a reference picture to and predicts P4, and P4 predicts B2, and so on, and each picture pointed to by a respective arrow would have at least one reference index in its compressed picture form to the reference picture at the tail of that arrow. Note that not all interdependencies are shown to avoid unduly complicating the diagram. Row 604 illustrates a decode or transmission order of the picture sequence 602, with the understanding that other pictures may be interspersed therein. Row 606 illustrates the respective tier number of the pictures shown in row 604. An assumption is made for purposes of these examples of a lowest tier number of ‘1’ and highest tier number of ‘7’, with the understanding that other tier number assignments or designations may be used.

Referring to FIG. 6B, a table 608 is shown that identifies the picture number (PN), picture order count (POC), picture type, and tier number for the example picture sequence 602 of FIG. 6A. The “I” (or IDR) picture (I1) is associated with tier 1, the forward predicted pictures (P4 and P8) are associated with tier 2, and so on as shown in FIG. 6B. The currently decoded picture is identified by reference numeral 610, and the pictures yet to be decoded are identified by reference numeral 612.

FIG. 6C shows the L0 ascending reference 614 (it is noted, as explained above, that with a B picture as the currently decoded picture, two reference picture lists are used), the respective associated picture number 616, and the tier number 618 associated with each picture number for a default or normal playback mode. A reference picture list for the currently decoded picture 610 (e.g., picture number 3 or P8 in this example) consists of L0, and for the current example, has picture number 2 (a Tier 3 picture) associated with reference index 0, PN equal to 1 (a Tier 2 picture) associated with reference index 1, and PN equal to 0 (a Tier 1 picture) associated with associated with reference index 2. The reference picture list is derived as explained in association with FIGS. 5A-5C.

FIG. 6D shows the L0 ascending reference 620 (note that with a B picture two reference picture lists are used), the respective associated picture number 622, and the tier number 624 associated with each picture number for a Tier 2 trick mode operation. As noted from table 608 and the diagram of FIG. 6D, a tier 2 trick mode operation comprises DPB reference pictures corresponding tiers 1 and 2, which in this example include I1 and P4, respectively. It is noted that, depending on the playback mode, reference index 1, for instance, is associated with a different picture number. Certain embodiments described below address these and other shortcomings in PVR functionality.

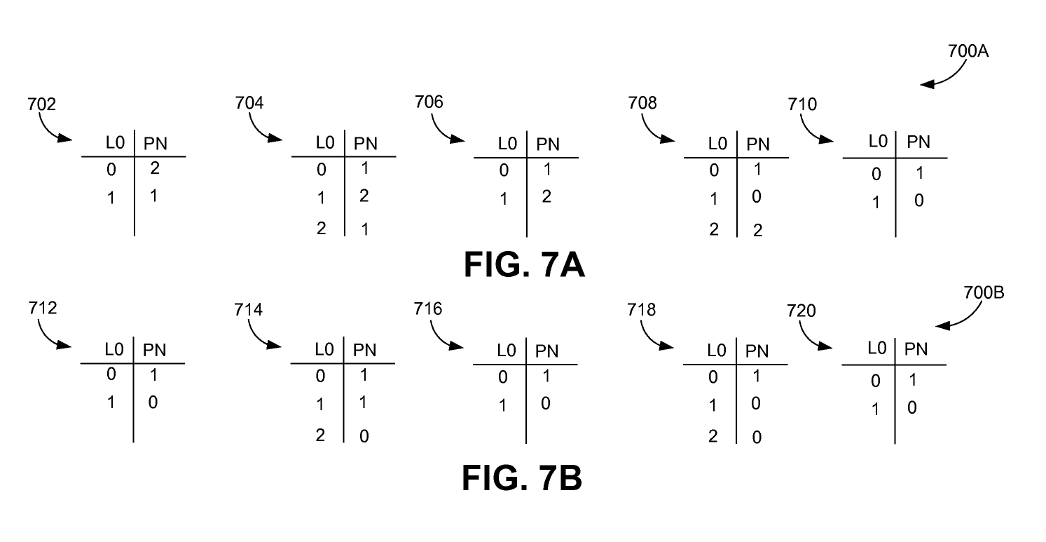

Referring to FIGS. 7A-7B, shown are block diagrams that illustrate method embodiments 700A and 700B, respectively, that modify the picture associations to the ascending reference indices of the default reference picture list (e.g., a reference picture list corresponding to FIG. 6C) to match the associations needed for a requested trick mode (e.g., a reference picture list corresponding to FIG. 6D). In general, the PVRA method embodiments 700 (including 700A and 700B) lower, from a default value, the maximum allowed reference index (e.g., a parameter of slice header syntax of AVC) to a reference picture list to correspond to the number of pictures used by the current picture minus one (e.g., since the first index is zero (0)) or in some embodiments, lower, from a default value, the reference index for all reference pictures in the DPB with tier numbers lower or equal to the tier number of the current pictures. The PVRA method embodiments 700 issue RPRCs that work in concert with the lower maximum reference index for proper indexing of reference pictures during normal playback and trick modes. In some embodiments, the RPRC is asserted for each reference picture for the currently decoded picture. In effect, the changed maximum reference index and the RPRCs push the lower tier numbered pictures of the default reference picture list to the top of a modified reference picture list.

Referring now to FIG. 7A and PVRA method 700A (e.g., with all reference pictures present in the DPB), two RPRCs are used in this example. Reference picture list 702 corresponds to a default reference picture list (e.g., based on FIG. 6C) truncated by explicitly lowering the maximum reference index to the number of pictures used by the current picture (PN=3 from FIG. 6B), which is a num_ref idx_{—}10_active_minus1 (from AVC) equal to 1. The PVRA method 700A, pursuant to issuance of a first RPRC, pushes (slides, shifts, etc.) down the picture number entries by one, leaving open the PN entry corresponding to reference index 0 and enabling insertion of PN=1 to the indexed entry as shown in modified reference picture list 704. Note that one having ordinary skill in the art should understand that multiple pointers may be used in the operations on the lists, as expressed in AVC, though other mechanisms may be employed in some embodiments. The modified reference picture list is truncated to two associations as shown in modified reference picture list 706.

Pursuant to issuance of a second RPRC, the PVRA method 700A slides down (from the second entry corresponding to the association of reference index 1) picture number 2, which leaves a picture number entry open in association with reference index 1. The PVRA method 700A inserts PN=0 (which exists in the DPB though not referenced in the truncated default reference picture list 702), as shown in modified reference picture list 708. Once again, the PVRA method 700A removes the last entry associated with reference index 2 (from reference picture list 708), resulting in the modified reference picture list 710 corresponding to a Tier 2 trick mode.

FIG. 7B follows a similar process, yet for the situation where only Tier 2 frames are present. For instance, pursuant to a first RPRC, the PVRA method 700B truncates a default reference picture list according to the lowered maximum reference index and populates the picture entries with Tier 2 frames (PN=1 at reference index 0, PN=0 at reference index=1), as shown in 712. At 714, the PVRA method 700B slides down picture number entries (from reference index 1) and inserts picture number 1 in association with the opened-up reference index 0. At 716, the PVRA method 700B truncates the modified reference picture list, removing the previously existing picture number 1 entry and associated reference index 1. The PVRA method 700B issues a second RPRC command, effecting insertion (at an opened entry, opened via a slide of the picture number) of PN=0 at the second reference index and an increased reference index/picture association entry, as shown in modified reference picture list 718. Once again, at 720, the modified reference picture list is truncated, resulting in the Tier 2 trick mode modified reference picture list.

Note that in some embodiments, fewer or more RPRC commands may be issued depending on the choice of the maximum reference index value and the arrangement of reference pictures. In this particular example illustrated in FIGS. 7A-7B, fewer commands may be implemented to achieve the same result. For instance, by setting the maximum reference index value lower by 1 (i.e., num_ref idx_{—}10_active_minus1 (from AVC) equal to 0), a single RPRC may be issued to achieve a modified reference picture list (corresponding to a Tier 2 trick mode) where PN=1 at reference index 0, since reference indices 1 and 2 would be discarded.

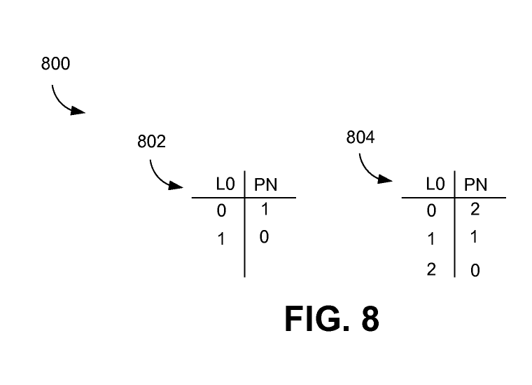

In another method embodiment 800, illustrated in FIG. 8, the PVRA method 800 recreates at the VSRP device 120 a default reference picture list. For instance, the decoding logic (or other components of the VSRP device 120, such as the PVR application 314, alone or in cooperation with the decoding logic) scans a default reference picture list responsive to one or more modify commands (i.e., the number of modify commands required to generate the default reference picture list) by finding the highest reference index number (referred to hereinafter as Index_T) for which the tier number is greater than the tier number of the current picture. The one or more modify commands prompt the re-creation of the default reference picture list that is derived during a normal playback mode (referred to hereinafter as normal playback default reference picture list). Note that such modify commands do not actually modify the reference picture list during normal playback mode but rather, leaves the reference picture list intact. However, during a trick mode, in the absence of the modify command, the normal playback default reference picture list may or may not be generated, and the effect of the modify commands is to generate the normal playback default reference picture list. In one embodiment, Index_T+1 modify commands are issued to generate the normal playback default reference picture list, and each command respectively asserts the default PicNum associated for each corresponding reference index from reference index 0 to Index_T.

Note that all modify commands at the decoding logic are executed regardless of whether performing a normal playback mode or a trick mode operation. Also, the same modify commands are issued during normal playback modes and trick modes. However, the derived default reference picture list (e.g., prior to executing the modify commands) for normal playback mode is a first default reference picture list that may be different from a second reference picture list derived prior to executing the modify commands while performing a trick mode operation. In one embodiment, to guarantee that referencing of pictures during normal playback and trick modes is correct, one or more modify commands are issued according to a determination of whether a reference picture with a higher tier number (e.g., higher than the tier number of the picture being decoded) is located at a lower reference index of the reference picture list than a picture referenced by the current picture being decoded. Note that in one embodiment, the encoder 116 provides a video stream with a fixed frame rate and no gaps (per the definition of H.264) and no “non-existing” pictures.

Returning to the discussion of FIG. 8, shown is a reference picture list 802 corresponding to trick mode functionality, and the process (explained above) by which the PVRA method 800 recreates or generate the normal playback default reference picture list. In this example, scanning the default reference picture list (e.g., corresponding to FIG. 6C), it is noted that the highest reference index number for which the tier number is greater than the tier number of the current picture (PN=3, with tier number 2) is at the top of the list (PN=2, having a tier number 3). Accordingly, upon issuance of a single modify command, the first picture entry shown in reference picture list 802 is pushed down, and PN=2 is inserted in the opened entry associated with the first reference index (e.g., reference index 0) as shown in modified or recreated reference picture list 804. It is also noted that, in a given trick mode, the inserted picture (e.g., PN=2) may be ignored since it is of a higher tier number. However, such a possibility does not alter the trick mode operation as long as the default reference picture list has been recreated, since the indices are considered correct.

In one embodiment, the PVRA method 800 may implement the above in these or other circumstances or default reference picture list arrangements based on the following example, non-limiting algorithm (in pseudo code): in the default reference picture list, find the highest index number for which the tier_num>tier_num_of current_pic, and let that index be index_mod. Then, for (i=0; i<(index_mod+1); i++, issue a reference picture list modification command, with an end effect of re-populating to a default reference picture list. It should be appreciated within the context of the present disclosure that other mechanisms may be used to implement the recreate functionality.

Note that in some embodiments, the encoder 116 chooses among these two PVRA methods based on, for instance, which of these two methods when implemented results in the least number of issued modify commands Further, in some embodiments, other methods may be employed that reach the same respective result.

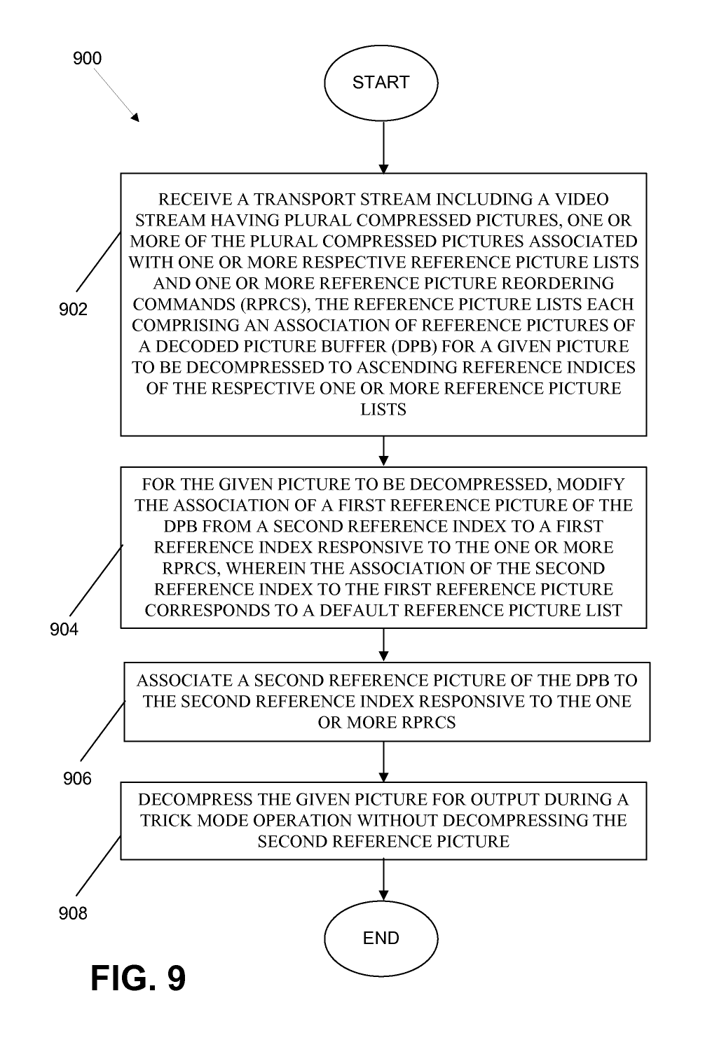

It should be appreciated that one PVRA method embodiment 900, shown in FIG. 9 and implemented by the VSRP device 120, comprises receiving a transport stream including a video stream having plural compressed pictures, one or more of the plural compressed pictures associated with one or more respective reference picture lists and one or more reference picture reordering commands (RPRCs), the reference picture lists each comprising an association of reference pictures of a decoded picture buffer (DPB) for a given picture to be decompressed to ascending reference indices of the respective one or more reference picture lists (902); for the given picture to be decompressed, modifying the association of a first reference picture of the DPB from a second reference index to a first reference index responsive to the one or more RPRCs, wherein the association of the second reference index to the first reference picture corresponds to a default reference picture list (904); associating a second reference picture of the DPB to the second reference index responsive to the one or more RPRCs (906); and decompressing the given picture for output during a trick mode operation without decompressing the second reference picture (908).

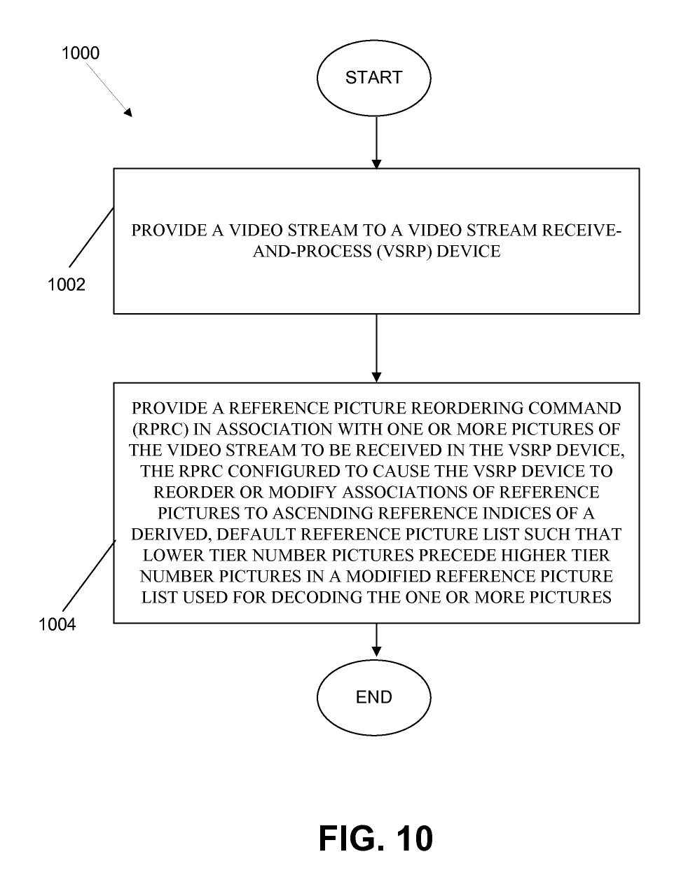

FIG. 10 is a flow diagram that illustrates one example method embodiment 1000 implemented by an encoder in an embodiment of a PVRA system, including providing a video stream to a video stream receive-and-process (VSRP) device (1002); and providing a reference picture reordering command (RPRC) in association with one or more pictures of the video stream to be received in the VSRP device, the RPRC configured to cause the VSRP device to reorder or modify associations of reference pictures to ascending reference indices of a derived, default reference picture list such that lower tier number pictures precede higher tier number pictures in a modified reference picture list used for decoding the one or more pictures (1004).

Any process descriptions or blocks in flow charts or flow diagrams should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art. In some embodiments, steps of a process identified in FIGS. 9-10 (using separate boxes) or explained in association with FIGS. 7A-8B can be combined. Further, the various steps in or in association with the diagrams (7A-10) illustrated in conjunction with the present disclosure are not limited to the architectures described above in association with the description for those diagram (as implemented in or by a particular module or logic) nor are the steps limited to the example embodiments described in the specification and associated with the figures of the present disclosure. In some embodiments, one or more steps may be added to one or more of the methods described in FIGS. 7A-10, either in the beginning, end, and/or as intervening steps, and that in some embodiments, fewer steps may be implemented.

It should be emphasized that the above-described embodiments of the disclosure are merely possible examples, among others, of the implementations, setting forth a clear understanding of the principles of the PVRA systems and methods. For instance, the PVR application 314 in some embodiments may reorder associations during some instances of normal playback based on signaling by the encoder 116. Many variations and modifications may be made to the above-described embodiments without departing substantially from the principles set forth herein. Although all such modifications and variations are intended to be included herein within the scope of this disclosure and protected by the following claims, the following claims are not necessarily limited to the particular embodiments set out in the description.

What is claimed is:

1. A method, comprising:
receiving at a video stream receive-and-process (VSRP) device a transport stream including a video stream having plural compressed pictures, one or more of the plural compressed pictures associated with one or more respective reference picture lists and one or more reference picture reordering commands (RPRCs), the reference picture lists each comprising an association of reference pictures of a decoded picture buffer (DPB) for a given picture to be decompressed to ascending reference indices of the respective one or more reference picture lists;
for the given picture to be decompressed, modifying the association of a first reference picture of the DPB from a second reference index to a first reference index responsive to the one or more RPRCs, wherein the association of the second reference index to the first reference picture corresponds to a default reference picture list;
associating a second reference picture of the DPB to the second reference index responsive to the one or more RPRCs; and
decompressing the given picture for output during a trick mode operation without decompressing the second reference picture.

2. The method of claim 1, wherein receiving comprises receiving an indication in a transport packet of the transport stream whether a command for modifying reference picture lists is present in the transport stream.

3. The method of claim 1, wherein the transport stream further comprises plural types of modifying commands.

4. The method of claim 1, further comprising receiving a maximum allowed reference index to a reference picture list lower in value than a default maximum allowed reference index value to correspond to the number of pictures used by the given picture minus one.

5. The method of claim 1, further comprising receiving a maximum allowed reference index to a reference picture list lower in value than a default maximum allowed reference index value to correspond to the reference index for all reference pictures in the DPB with tier numbers lower or equal to the tier number of the current pictures.

6. The method of claim 1, wherein the video stream comprises a fixed frame rate and no gaps and no non-existing pictures.

7. The method of claim 1, wherein the VSRP device comprises a set-top box.

8. The method of claim 1, further comprising outputting the decompressed picture for display on a display device.

9. The method of claim 1, further comprising, responsive to a normal playback mode, decompressing and outputting the first reference picture and the second reference picture.

10. The method of claim 1, wherein the trick mode operation comprises a playback different than normal playback.

11. A system, comprising:
an encoder, comprising:
memory with personal video recording assist (PVRA) logic; and
a processor configured to execute the PVRA logic to:
provide a reference picture reordering command (RPRC) in association with one or more pictures of a video stream to be received in a video stream receive-and-process (VSRP) device, the RPRC configured to cause the VSRP device to reorder or modify associations of reference pictures to ascending reference indices of a derived, default reference picture list such that lower tier number pictures precede higher tier number pictures in a modified reference picture list used for decoding the one or more pictures.

12. The system of claim 11, wherein the processor is further configured with the PVRA logic to lower, from a default value, the maximum allowed reference index to a reference picture list to correspond to the number of pictures used by the current picture minus one.

13. The system of claim 11, wherein the processor is further configured with the PVRA logic to lower, from a default value, the reference index for all reference pictures in a decoded picture buffer with tier numbers lower or equal to the tier number of the current pictures.

14. The system of claim 11, wherein the processor is further configured with the PVRA logic to provide plural types of modification commands in association with the video stream.

15. The system of claim 11, wherein the processor is further configured with the PVRA logic to provide the video stream at a fixed frame rate with no gaps and no non-existing pictures.

16. The system of claim 11, wherein the processor is further configured with the PVRA logic to provide an indication in a transport packet of a transport stream that includes the video stream whether a command for modifying reference picture lists is present in the transport stream.

17. The system of claim 11, further comprising the VSRP device, the VSRP device configured with logic and a processor that executes the logic to cause the VSRP device to reorder or modify the associations of reference pictures to ascending reference indices of the derived, default reference picture list such that the lower tier number pictures precede the higher tier number pictures in the modified reference picture list used for decoding the one or more pictures

18. A video stream receive-and-process (VSRP) device, comprising logic configured to, responsive to reception of one or more modify commands received in a video stream, the one or more modify commands required to generate a default reference picture list, scan a default reference picture list by finding a highest reference index number for which its tier number is greater than a tier number of a current picture to be decoded.

19. The VSRP device of claim 18, wherein the logic is further configured to recreate a default reference picture list that is derived during a normal playback mode responsive to the one or more modify commands.

20. The VSRP device of claim 18, wherein the modify commands are received during normal playback and trick mode operations.
